(19) United States
(12) Patent Application Publication
(10) Pub. No.: US 2024/0270908 A1
(43) Pub. Date: Aug. 15, 2024

(54) POLYSILSESQUIOXANE COMPOSITION AND CURED PRODUCT

(71) Applicant: NIPPON SHOKUBAI CO., LTD., Osaka-shi, Osaka (JP)

(72) Inventors: Jun-ichi NAKAMURA, Osaka (JP); Nobuhiro MAEDA, Osaka (JP)

(21) Appl. No.: 18/551,764

(22) PCT Filed: Mar. 22, 2022
(86) PCT No.: PCT/JP2022/013113

§ 371 Date: Apr. 24, 2024

(30) Foreign Application Priority Data
Mar. 25, 2021 (JP) 2021-052091

(51) Int. Cl. C08G 77/04; C08K 5/09; C08K 5/13; C08K 5/3492; C08K 5/5317

(52) U.S. Cl. CPC C08G 77/045; C08K 5/09; C08K 5/13; C08K 5/3492; C08K 5/5317

(57) ABSTRACT

The present invention provides a curable composition capable of providing a cured product having excellent resistance to thermal decomposition and excellent adhesion to metal base materials. The present invention relates to a polysilsesquioxane composition containing: a polysilsesquioxane; and at least one compound selected from the group consisting of phosphorus-containing compounds, triazinethiol compounds, hydroxy group-containing compounds having a boiling point of 230° C. or higher, and carboxy group-containing compounds having a boiling point of 230° C. or higher, the phosphorus-containing compounds including at least one selected from the group consisting of phosphine compounds, phosphate compounds, phosphinate compounds, and phosphonate compounds.

### TECHNICAL FIELD

The present invention relates to polysilsesquioxane compositions. Specifically, the present invention relates to a polysilsesquioxane composition capable of providing a cured product having excellent resistance to thermal decomposition and excellent adhesion to metal base materials. The present invention also relates a cured product thereof.

### BACKGROUND ART

Silicon-based compounds such as polysilsesquioxanes have physical properties of organic functional groups and ceramics and thus can impart various properties. Such silicon-based compounds have been widely used as raw materials for various industrial products in the fields of electronics, optoelectronic devices, and displays, and related fields.

Various studies have been made so far on curable compositions containing silicon-based compounds.

For example, Patent Literature 1 discloses a composition containing a silicon-containing compound having an alkyl group and an aryl group, a heat-activated condensation catalyst, and a solvent.

Patent Literature 2 discloses a crosslinkable composition containing a first silicon-containing resin having alkyl groups and aryl groups, a second silicon-containing resin having aryl groups, a solvent, and a heat-activated catalyst, wherein the first silicon-containing resin has a weight average molecular weight from 1000 AMU to 10000 AMU and the second silicon-containing resin has a weight average molecular weight from 900 AMU to 5000 AMU.

### CITATION LIST

### Patent Literature

Patent Literature 1: JP 2014-208838 A

Patent Literature 2: JP 2018-516998 T

### SUMMARY OF INVENTION

### Technical Problem

Conventional curable compositions containing silicon-based compounds however do not have a sufficiently high thermal decomposition temperature, and thus do not have sufficient resistance to thermal decomposition for some uses. Moreover, the cured products obtained from such curable compositions have the disadvantage of exhibiting low adhesion to base materials, particularly to metal base materials. Thus, the curable compositions have been required to be improved so as to exhibit higher resistance to thermal decomposition and higher adhesion to metal base materials, enabling their use in a wider range of uses.

The present invention has been made in view of the above-mentioned current situation, and aims to provide a curable composition capable of providing a cured product having excellent resistance to thermal decomposition and excellent adhesion to metal base materials.

### Solution to Problem

The present inventors have made various studies on compositions containing polysilsesquioxanes, and found that a composition containing a polysilsesquioxane and a specific compound can provide a cured product having a high thermal decomposition temperature and improved resistance to thermal decomposition because the specific compound acts not only as a catalyst but also as a heat resistance improver. The present inventors have also found that a cured product obtained from such a composition has excellent adhesion particularly to metal base materials. Thus, the present inventors completed the present invention.

That is, the present invention relates to a polysilsesquioxane composition containing:
a polysilsesquioxane; and
at least one compound selected from the group consisting of phosphorus-containing compounds, triazinethiol compounds, hydroxy group-containing compounds having a boiling point of 230° C. or higher, and carboxy group-containing compounds having a boiling point of 230° C. or higher,
the phosphorus-containing compounds including at least one selected from the group consisting of phosphine compounds, phosphate compounds, phosphinate compounds, and phosphonate compounds.

Preferably, the polysilsesquioxane is a compound containing a backbone represented by the following formula (1):

[R¹SiO_{1.5}]ₙ (1)

wherein R¹ represents an alkyl group having a carbon number of 1 to 10, an aryl group, or a vinyl structure-containing group; the alkyl group having a carbon number of 1 to 10 and the aryl group each optionally have a substituent; and n R¹s are optionally the same as or different from each other.

Preferably, the polysilsesquioxane contains an alkyl group having a carbon number of 1 to 10 and an aryl group as R¹s in the formula (1).

Preferably, the polysilsesquioxane contains an alkyl group having a carbon number of 3 to 10 and an aryl group as R¹s in the formula (1).

Preferably, the polysilsesquioxane contains a methyl group, an alkyl group having a carbon number of 3 to 10, and an aryl group as R¹s in the formula (1).

Preferably, the polysilsesquioxane contains an alkyl group having a carbon number of 3 to 10, an aryl group, and a vinyl structure-containing group as R¹s in the formula (1).

Preferably, an amount of carbon in the alkyl group having a carbon number of 3 to 10 is 3% by mass or more of a total amount of carbon in the polysilsesquioxane.

Preferably, the polysilsesquioxane contains a structural unit represented by the following formula (1′) in an amount of 40 mol % or more based on 100 mol % of all structural units of the polysilsesquioxane,

[R¹SiO_{1.5}] (1′)

wherein R¹ represents an alkyl group having a carbon number of 1 to 10, an aryl group, or a vinyl structure-containing group; and the alkyl group having a carbon number of 1 to 10 and the aryl group each optionally have a substituent.

Preferably, the polysilsesquioxane further contains a backbone represented by the following formula (2):

[R²R³SiO_{1.0}]ₘ (2)

wherein R² and R³ are the same as or different from each other and each represent an alkyl group having a carbon number of 1 to 10, an aryl group, a vinyl structure-containing group, or —OR⁴; the alkyl group having a carbon number of 1 to 10 and the aryl group each optionally have a substituent; R⁴ represents a hydrogen atom, an alkyl group, an aryl group, or an acetyl group; and m R²s are optionally the same as or different from each other and m R³s are optionally the same as or different from each other.

Preferably, the phosphine compounds have a boiling point of 100° C. or higher.

Preferably, the polysilsesquioxane composition further contains a hindered phenolic antioxidant.

Preferably, the polysilsesquioxane composition is for use in an optical material.

Preferably, the polysilsesquioxane composition is for use in a low dielectric material.

The present invention also relates to a cured product obtained by curing the polysilsesquioxane composition.

### Advantageous Effects of Invention

The polysilsesquioxane composition of the present invention can provide a cured product having excellent resistance to thermal decomposition and excellent adhesion to metal base materials. The polysilsesquioxane composition of the present invention is suitable for various uses such as electric/electronic components, optical components, and display devices.

### DESCRIPTION OF EMBODIMENTS

The present invention is described in detail below.

A combination of two or more of individual preferred embodiments of the present invention described below is also a preferred embodiment of the present invention.

### 1. Polysilsesquioxane Composition

The present invention relates to a polysilsesquioxane composition containing: a polysilsesquioxane; and at least one compound selected from the group consisting of phosphorus-containing compounds, triazinethiol compounds, hydroxy group-containing compounds having a boiling point of 230° C. or higher, and carboxy group-containing compounds having a boiling point of 230° C. or higher, the phosphorus-containing compounds including at least one selected from the group consisting of phosphine compounds, phosphate compounds, phosphinate compounds, and phosphonate compounds. The polysilsesquioxane composition of the present invention can provide a cured product having excellent resistance to thermal decomposition and excellent adhesion to metal base materials.

The reason why the polysilsesquioxane composition of the present invention can provide a cured product having excellent resistance to thermal decomposition and excellent adhesion to metal base materials is presumably as follows. The at least one compound selected from the group consisting of phosphorus-containing compounds, triazinethiol compounds, hydroxy group-containing compounds having a boiling point of 230° C. or higher, and carboxy group-containing compounds having a boiling point of 230° C. or higher serves as a heat resistance improver to allow the cured product of the polysilsesquioxane composition to have improved resistance to thermal decomposition. Thereby, the compound mediates interaction between the resin and a metal base material to give improved adhesion therebetween.

The components contained in the polysilsesquioxane composition of the present invention are described.

### Polysilsesquioxane

Polysilsesquioxanes are compounds having siloxane bonds (Si—O—Si) obtained by hydrolysis and condensation of trifunctional organoalkoxysilanes.

The polysilsesquioxane preferably contains a backbone represented by the following formula (1):

[R¹SiO_{1.5}]ₙ (1)

wherein R¹ represents an alkyl group having a carbon number of 1 to 10, an aryl group, or a vinyl structure-containing group; the alkyl group having a carbon number of 1 to 10 and the aryl group each optionally have a substituent; and n R¹s may be the same as or different from each other.

The backbone represented by the formula (1) contains a structural unit containing a silicon atom bonded to three oxygen atoms (T-structure).

Such a polysilsesquioxane is well compatible with the specific compound described below and can lead to a cured product having improved transparency.

In the formula (1), R¹ represents an alkyl group having a carbon number of 1 to 10, an aryl group, or a vinyl structure-containing group.

The alkyl group having a carbon number of 1 to 10 may be linear or branched. In terms of improving the flexibility, it is preferably linear.

In terms of improving the flexibility of the cured product, the alkyl group having a carbon number of 1 to 10 is preferably an alkyl group having a carbon number of 3 to 10. The presence of a flexible unit of an alkyl group having a carbon number of 3 to 10 allows the cured product to exhibit flexibility. If the carbon number in the alkyl group is more than 10, the surface hardness of the cured product may be reduced.

The alkyl group is more preferably an alkyl group having a carbon number of 3 to 8, even more preferably an alkyl group having a carbon number of 3 to 6. Here, the carbon number refers to the number of carbon atoms of the alkyl groups, excluding the number of carbon atoms of the substituents.

Examples of the alkyl group include methyl, ethyl, n-propyl, isopropyl, n-butyl, tert-butyl, sec-butyl, isobutyl, n-pentyl, isopentyl, neopentyl, n-hexyl, 2-methylpentyl, 3-methylpentyl, 2,2-dimethylbutyl, 2,3-dimethylbutyl, heptyl, 2-methylhexyl, 3-methylhexyl, 2,2-dimethylpentyl, 2,3-dimethylpentyl, 2,4-dimethylpentyl, 3-ethylpentyl, 2,2,3-trimethylbutyl, n-octyl, methylheptyl, dimethylhexyl, 2-ethylhexyl, 3-ethylhexyl, trimethylpentyl, 3-ethyl-2-methylpentyl, 2-ethyl-3-methylpentyl, 2,2,3,3-tetramethylbutyl, n-nonyl, methyloctyl, 3,7-dimethyloctyl, dimethylheptyl, 3-ethylheptyl, 4-ethylheptyl, trimethylhexyl, 3,3-diethylpentyl, and n-decyl groups.

In terms of industrial availability, the alkyl group is preferably at least one selected from the group consisting of n-propyl, isopropyl, n-butyl, isobutyl, n-hexyl, n-octyl, and n-decyl groups among these. In terms of easily achieving both high surface hardness and high flexibility of the cured product, the alkyl group is more preferably an n-propyl group, an n-butyl group, or an isobutyl group, even more preferably an n-propyl group.

Examples of the aryl group include phenyl, styryl, tolyl, xylyl, biphenyl, terphenyl, naphthyl, fluorenyl, phenanthryl, and anthracenyl groups.

In terms of improving the solubility in an organic solvent, the aryl group is preferably a phenyl group, a styryl group, a tolyl group, or a xylyl group, more preferably a phenyl group or a styryl group, even more preferably a phenyl group among these.

The alkyl group and the aryl group may each have a substituent. Examples of the substituent include alkyl, aryl, and alkenyl groups.

Examples of the alkyl group and the aryl group include the same groups as those described above.

Examples of the alkenyl group include vinyl, propenyl, isopropenyl, butenyl, isobutenyl, tert-butenyl, pentenyl, hexenyl, heptenyl, and octenyl groups.

The carbon number in the substituent is preferably 1 to 10, more preferably 1 to 6, even more preferably 1 to 4.

The alkyl group having a carbon number of 1 to 10 and the aryl group may each have one or more of the substituents.

The vinyl structure-containing group refers to a group containing a vinyl structure represented by “CH₂═C(R^{a})—”, where R^{a} represents a hydrogen atom or an alkyl group having a carbon number of 1 to 3. The polysilsesquioxane containing the vinyl structure-containing group can provide a cured product having excellent toughness and solvent resistance.

An example of the vinyl structure-containing group is a group represented by CH═C(R^{a})—(X)ₘ—, where R^{a} is the same as described above, X represents a divalent organic group, and m is 0 or 1.

R^{a} is preferably a hydrogen atom or a methyl group.

Examples of the divalent organic group represented by X include a divalent hydrocarbon group; a bonding group such as —CO—, —COO—, —NH₂—, —S—, or —C₆H₄—; and combinations thereof.

Specific examples of the vinyl structure-containing group include vinyl, acryloyl, methacryloyl, and allyl groups. In terms of industrial availability, vinyl, acryloyl, and methacryloyl groups are preferred among these. In terms of being less susceptible to hydrolysis, a vinyl group is more preferred.

The polysilsesquioxane may contain as R¹s in the formula (1) a plurality of groups selected from the alkyl group having a carbon number of 1 to 10, the aryl group, and the vinyl structure-containing group.

In other words, the polysilsesquioxane may be a compound containing at least two or more backbones selected from a backbone represented by the formula (1) in which R¹ is the alkyl group having a carbon number of 1 to 10, a backbone represented by the formula (1) in which R¹ is the aryl group, and a backbone represented by the formula (1) in which R¹ is the vinyl structure-containing group.

In particular, in terms of easy synthesis of the polysilsesquioxane, the polysilsesquioxane preferably contains the alkyl group having a carbon number of 1 to 10 and the aryl group as R¹s in the formula (1).

In terms of improving the surface hardness and flexibility of the cured product, preferably, the polysilsesquioxane contains the alkyl group having a carbon number of 3 to 10 and the aryl group as R¹s in the formula (1).

In terms of improving the surface hardness, flexibility, and toughness of the cured product, preferably, the polysilsesquioxane contains a methyl group, the alkyl group having a carbon number of 3 to 10, and the aryl group as R¹s in the formula (1).

In terms of improving the toughness and solvent resistance of the cured product, preferably, the polysilsesquioxane contains the alkyl group having a carbon number of 3 to 10, the aryl group, and the vinyl structure-containing group as R¹s in the formula (1).

In terms of industrial availability, the alkyl group having a carbon number of 3 to 10 is preferably at least one selected from the group consisting of n-propyl, isopropyl, n-butyl, isobutyl, n-hexyl, n-octyl, and n-decyl groups.

Preferably, the amount of carbon in the alkyl group is 3% by mass or more of the total amount of carbon in the polysilsesquioxane. When the amount of carbon in the alkyl group is within the above range, breaking (cracking) of the cured product can be easily reduced. In terms of improving the flexibility, the amount of carbon in the alkyl group is more preferably 10% by mass or more, even more preferably 15% by mass or more, of the total amount of carbon in the polysilsesquioxane. The upper limit of the carbon number in the alkyl group is not limited and is preferably 90% by mass or less, more preferably 70% by mass or less of the total amount of carbon in the polysilsesquioxane in terms of achieving both high surface hardness and high flexibility of the cured product.

When the amount of carbon in the alkyl group is within the above range, the alkyl group is particularly preferably an alkyl group having a carbon number of 3 to 10.

In the formula (1), n is an integer of 1 or more, and n R¹s may be the same as or different from each other. R¹s may include two or more different groups. In other words, the polysilsesquioxane may be a compound containing two or more different groups as R¹s in the formula (1).

The polysilsesquioxane preferably contains the backbone represented by the formula (1) in an amount of 40 mol % or more, more preferably 50 mol % or more, even more preferably 60 mol % or more, based on 100 mol % of the polysilsesquioxane.

The structure of the polysilsesquioxane and the amount of the backbone can be determined by ²⁹Si-NMR.

The backbone represented by the formula (1) contains a structural unit represented by the following formula (1′):

[R¹SiO_{1.5}] (1′)

wherein R¹ is the same as R¹ in the formula (1).

Preferably, the polysilsesquioxane contains a structural unit represented by the formula (1′) in an amount of 40 mol % or more based on 100 mol % of all structural units of the polysilsesquioxane.

Polysilsesquioxanes are compounds containing silicon-centered structural units each containing a silicon atom and atoms bonded to the silicon atom. In the polysilsesquioxane, the amount of the structural unit represented by the formula (1′) is preferably 40 mol % or more based on 100 mol % of the total amount of such silicon-centered structural units.

The polysilsesquioxane more preferably contains the structural unit represented by the formula (1′) in an amount of 50 mol % or more, even more preferably 60 mol % or more, based on 100 mol % of all structural units of the polysilsesquioxane.

The upper limit of the percentage of the structural unit represented by the formula (1′) is not limited and is preferably 90 mol % or less, more preferably 80 mol % or less, based on 100 mol % of all structural units of the polysilsesquioxane.

The structure of the polysilsesquioxane and the amount of the structural unit can be determined by ²⁹Si-NMR.

The polysilsesquioxane may be a compound consisting of a backbone represented by the formula (1) (also referred to as a condensation homopolymer), or may be a compound containing a backbone represented by the formula (1) and a different backbone other than the backbone represented by the formula (1) (also referred to as a condensation polymer), with the different backbone containing a different structural unit.

Examples of the condensation polymer include alternating condensation copolymers having a structure in which a backbone represented by the formula (1) in which n is 1 (i.e., a structural unit represented by the formula (1′)) and a different structural unit are alternately connected and copolymers having a structure in which a backbone represented by the formula (1) in which n is 2 or more and a different backbone containing a different structural unit are alternately or randomly connected.

Examples of the different backbone include a backbone represented by the formula (2), which is described below, and a backbone represented by [R⁵R⁶R⁷SiO_{0.5}]ₚ, which is described below, where R⁵, R⁶, R⁷, and p are as described below. Examples of the different structural unit include a structural unit represented by the formula (2′), which is described below, and a structural unit represented by [R⁵R⁶R⁷SiO_{0.5}], which is described below, where R⁵, R⁶, and R⁷ are as described below.

Preferably, the polysilsesquioxane further contains a backbone represented by the following formula (2):

[R²R³SiO_{1.0}]ₘ (2)

wherein R² and R³ are the same as or different from each other and each represent an alkyl group having a carbon number of 1 to 10, an aryl group, a vinyl structure-containing group, or —OR⁴; the alkyl group having a carbon number of 1 to 10 and the aryl group each optionally have a substituent; R⁴ represents a hydrogen atom, an alkyl group, an aryl group, or an acetyl group; and m R²s are optionally the same as or different from each other and m R³s are optionally the same as or different from each other.

The backbone represented by the formula (2) contains a structural unit containing a silicon atom bonded to two oxygen atoms (D-structure).

Preferred examples of the alkyl group having a carbon number of 1 to 10, the aryl group, and the vinyl structure-containing group for R² and R³ include the groups listed as the alkyl group having a carbon number of 1 to 10, the aryl group, and the vinyl structure-containing group for R¹ in the formula (1). In particular, R² and R³ are the same as or different from each other and each preferably represent an alkyl group having a carbon number of 1 to 10 or an aryl group, more preferably an alkyl group having a carbon number of 1 to 10, even more preferably an alkyl group having a carbon number of 1 to 2.

Examples of a substituent optionally present in the alkyl group having a carbon number of 1 to 10 and the aryl group include the groups listed as the substituent in R¹ in the formula (1).

Examples of the alkyl group and the aryl group for R⁴ include the groups listed as the alkyl group having a carbon number of 1 to 10 and the aryl group for R¹.

The alkyl group preferably has a carbon number of 1 to 5, more preferably 1 to 3, even more preferably 1 or 2.

R⁴ is preferably a hydrogen atom, an alkyl group, or an acetyl group, more preferably a hydrogen atom.

In the formula (2), m is an integer of 1 or more. The m R²s may be the same as or different from each other. The m R³s may be the same as or different from each other. In other words, the polysilsesquioxane may be a compound containing two or more different groups as R²s in the formula (2) and two or more different groups as R³s in the formula (2).

A specific example of the backbone represented by the formula (2) is a backbone represented by [R²SiO_{1.0}(OR⁴)]ₘ, where R² and R⁴ are the same as described above.

The backbone represented by the formula (2) contains a structural unit represented by the following formula (2′):

[R²R³SiO_{1.0}] (2′)

wherein R² and R³ are the same as R² and R³ in the formula (2), respectively.

The percentage of the structural unit represented by the formula (2′) in the polysilsesquioxane is preferably 1 to 60 mol %, more preferably 5 to 50 mol %, even more preferably 10 to 30 mol %, based on 100 mol % of all structural units of the polysilsesquioxane.

The amount of the structural unit represented by the formula (2′) can be determined by ²⁹Si-NMR.

When the polysilsesquioxane further contains the backbone represented by the formula (2), the percentage of the structural unit represented by the formula (2′) is preferably 1 mol % or more and 60 mol % or less, more preferably 5 mol % or more and 50 mol % or less, even more preferably 10 mol % or more and 40 mol % or less, based on 100 mol % of the total of the structural unit represented by the formula (1′) and the structural unit represented by (2′).

In addition to the backbones described above, the polysilsesquioxane may further contain a backbone represented by [R⁵R⁶R⁷SiO_{0.5}]ₚ, where R⁵, R⁶, and R⁷ are the same as or different from each other and each represent an alkyl group having a carbon number of 1 to 10, an aryl group, a vinyl structure-containing group, or —OR⁸; the alkyl group having a carbon number of 1 to 10 and the aryl group each optionally have a substituent; R⁸ represents a hydrogen atom, an alkyl group, an aryl group, or an acetyl group; and p R⁵s may be the same as or different from each other, p R⁶s may be the same as or different from each other, and p R⁷s may be the same as or different from each other.

Examples of this backbone include a structure (1) in which each of R⁵, R⁶, and R⁷ is an alkyl group having a carbon number of 1 to 10, an aryl group, or a vinyl structure-containing group and a structure (2) in which at least one of R⁵, R⁶, or R⁷ is —OR⁸. The structure (2) is preferred among these. Examples of the structure (2) include a structure (2-1) in which one of R⁵, R⁶, and R⁷ is —OR⁸ and the other two are each an alkyl group having a carbon number of 1 to 10, an aryl group, or a vinyl structure-containing group and a structure (2-2) in which two of R⁵, R⁶, and R⁷ are each —OR⁸ and the other one is an alkyl group having a carbon number of 1 to 10, an aryl group, or a vinyl structure-containing group.

Preferred examples of the alkyl group having a carbon number of 1 to 10, the aryl group, the vinyl structure-containing group, and —OR⁸ for R⁵, R⁶, and R⁷ include the groups listed as the alkyl group having a carbon number of 1 to 10, aryl group, vinyl structure-containing group, and —OR⁴ for R² or R³ in the formula (2).

The subscript p is an integer of 1 or more, and p R⁵s may be the same as or different from each other, p R⁶s may be the same as or different from each other, and p R⁷s may be the same as or different from each other.

The backbone represented by [R⁵R⁶R⁷SiO_{0.5}]ₚ contains a structural unit represented by [R⁵R⁶R⁷SiO_{0.5}], where R⁵, R⁶, and R⁷ are the same as described above (M-structure).

The polysilsesquioxane may have any of a random structure, a ladder structure, or a cage structure. Preferably, in terms of further improving the resistance to thermal decomposition, the polysilsesquioxane has a ladder structure or a cage structure.

In terms of improving the toughness of the cured product, the polysilsesquioxane preferably has a weight average molecular weight of 1,000 to 100,000, more preferably 3,000 to 50,000, even more preferably 5,000 to 20,000.

The weight average molecular weight can be determined by gel permeation chromatography (GPC) measurement, specifically by the method described in the EXAMPLES, which is described below.

The polysilsesquioxane can be synthesized by hydrolyzing and condensing a trialkoxysilane compound.

Examples of the trialkoxysilane compound include compounds represented by the following formula (3):

R⁹Si(OR¹⁰)₃ (3)

wherein R⁹ represents any of the groups listed above as R¹. R¹⁰ represents an alkyl group, an aryl group, or an acetyl group, and R¹⁰s may be the same as or different from each other.

Preferred examples of the alkyl group and the aryl group for R¹⁰ include the groups listed as the alkyl group and the aryl group for R¹ in the formula (1).

In the formula (3), three (OR¹⁰) groups may be the same as or different from each other, preferably the same as each other. R¹⁰ in (OR¹⁰) is preferably an alkyl group or an acetyl group, more preferably an alkyl group.

The alkyl group for R¹⁰ preferably has a carbon number of 1 to 5, more preferably 1 to 3, even more preferably 1 or 2.

Specific examples of the trialkoxysilane compound include alkyltrialkoxysilanes such as methyltrimethoxysilane, methyltriethoxysilane, ethyltrimethoxysilane, methyltriisopropoxysilane, n-propyltrimethoxysilane, n-propyltriethoxysilane, n-butyltrimethoxysilane, n-butyltriethoxysilane, isobutyltrimethoxysilane, isobutyltriethoxysilane, n-hexyltrimethoxysilane, n-hexyltriethoxysilane, n-octyltrimethoxysilane, n-octyltriethoxysilane, isooctyltrimethoxysilane, isooctyltriethoxysilane, n-decyltrimethoxysilane, and n-decyltriethoxysilane; aryltrialkoxysilanes such as phenyltrimethoxysilane, phenyltriethoxysilane, p-styryltrimethoxysilane, and p-styryltriethoxysilane; vinyl structure-containing trialkoxysilanes such as vinyltriethoxysilane, vinyltrimethoxysilane, 3-methacryloxypropyltrimethoxysilane, 3-methacryloxypropyltriethoxysilane, 3-acryloxypropyltrimethoxysilane, 3-acryloxypropyltriethoxysilane, allyltrimethoxysilane, and allyltriethoxysilane.

The trialkoxysilane compound may include one of these or two or more of these in combination.

The polysilsesquioxane further containing a backbone represented by the formula (2) can be synthesized by hydrolysis and condensation of a mixture containing the trialkoxysilane compound and a dialkoxysilane compound.

Examples of the dialkoxysilane compound include compounds represented by the following formula (4):

R¹¹R¹²Si(OR¹³)₂ (4)

wherein R¹¹ represents any of the groups listed above as R²; R¹² represents any of the groups listed above as R³; R¹¹ and R¹² may be the same as or different from each other; R¹³ is an alkyl group, an aryl group, or an acetyl group; and R¹³s may be the same as or different from each other.

Preferred examples of the alkyl group and the aryl group for R¹³ include the groups listed as the alkyl group and the aryl group for R⁴ in the formula (2).

In the formula (4), two (OR¹³) groups may be the same as or different from each other, preferably the same as each other. R¹³ in (OR¹³) is preferably an alkyl group or an acetyl group, more preferably an alkyl group.

The alkyl group for R¹³ preferably has a carbon number of 1 to 5, more preferably 1 to 3, even more preferably 1 or 2.

Specific examples of the dialkoxysilane compound include alkyldialkoxysilanes such as dimethyldimethoxysilane, diethyldimethoxysilane, dipropyldimethoxysilane, methylethyldimethoxysilane, methylpropyldimethoxysilane, methylbutyldimethoxysilane, methylpentyldimethoxysilane, methylhexyldimethoxysilane, methylheptyldimethoxysilane, methyloctyldimethoxysilane, methylnonyldimethoxysilane, methyldecyldimethoxysilane, dimethyldiethoxysilane, diethyldiethoxysilane, dipropyldiethoxysilane, methylethyldiethoxysilane, methylpropyldiethoxysilane, methylbutyldiethoxysilane, methylpentyldiethoxysilane, methylhexyldiethoxysilane, methylheptyldiethoxysilane, methyloctyldiethoxysilane, methylnonyldiethoxysilane, methyldecyldiethoxysilane, methylethyldipropoxysilane, methylpropyldipropoxysilane, methylbutyldipropoxysilane, methylpentyldipropoxysilane, methylhexyldipropoxysilane, methylheptyldipropoxysilane, methyloctyldipropoxysilane, methylnonyldipropoxysilane, methyldecyldipropoxysilane, dimethyldipropoxysilane, diethyldipropoxysilane, and dipropyldipropoxysilane; alkylaryldialkoxysilanes such as methylphenyldimethoxysilane, methylnaphthyldimethoxysilane, methylbenzyldimethoxysilane, methylphenyldiethoxysilane, methylnaphthyldiethoxysilane, methylbenzyldiethoxysilane, methylphenyldipropoxysilane, methylnaphthyldipropoxysilane, and methylbenzyldipropoxysilane; and diaryldialkoxysilanes such as diphenyldimethoxysilane, diphenyldiethoxysilane, and diphenyldipropoxysilane. Preferred among these is dimethyldiethoxysilane in terms of easy availability of its industrial product and easy synthesis.

The dialkoxysilane compound may include one of these or two or more of these in combination.

The trialkoxysilane compound and the dialkoxysilane compound may be hydrolyzed and condensed by any method. For example, a known method may be used in which the trialkoxysilane compound or a mixture of the trialkoxysilane compound and the dialkoxysilane compound is heated and reacted in the presence of water.

The amount of water used in the hydrolysis and condensation is preferably 0.5 to 10.0 mol, more preferably 0.5 to 5.0 mol, even more preferably 0.5 to 2.0 mol per mol of the alkoxyl groups contained in the trialkoxysilane compound and the dialkoxysilane compound used as raw materials.

The heating temperature is preferably 40° C. to 200° C., more preferably 50° C. to 180° C., even more preferably 60° C. to 180° C.

The reaction time is preferably 1 to 40 hours, more preferably 2 to 30 hours, even more preferably 4 to 20 hours.

The heating is preferably performed, for example, by a method in which a solution prepared by mixing the trialkoxysilane compound or the mixture, water, a solvent, and other components is first heated to 60° C. to 80° C., the temperature is then increased to 120° C. to 180° C., and the solution is then allowed to stand for about 4 to 20 hours. This heating method promotes the hydrolysis and condensation and can thereby provide a polysilsesquioxane containing a larger amount of the backbone represented by the formula (1).

The temperature is preferably increased at a rate of 5° C. to 20° C./hour, more preferably at a rate of 5° C. to 10° C./hour.

The hydrolysis and condensation may be performed in the atmosphere. The hydrolysis and condensation of the trialkoxysilane compound and the dialkoxysilane compound each having an aryl group or an alkyl group is preferably performed in an inert gas atmosphere such as a nitrogen or argon atmosphere. The hydrolysis and condensation of the trialkoxysilane compound and the dialkoxysilane compound each having a vinyl structure-containing group is preferably performed with bubbling of an oxygen/nitrogen (7/93 (v/v)) gas mixture.

In the hydrolysis and condensation, commonly used known components such as solvents, catalysts, and surfactants may be further used.

Examples of the solvents include the following solvents, one or more of which may be used.

Examples include water; monoalcohols such as methanol, ethanol, isopropanol, n-butanol, and s-butanol; glycols such as ethylene glycol and propylene glycol; cyclic ethers such as tetrahydrofuran and dioxane; glycol monoethers such as ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monomethyl ether, propylene glycol monoethyl ether, propylene glycol monobutyl ether, and 3-methoxybutanol; glycol ethers such as ethylene glycol dimethyl ether, ethylene glycol diethyl ether, ethylene glycol ethyl methyl ether, diethylene glycol dimethyl ether, diethylene glycol diethyl ether, diethylene glycol ethyl methyl ether, propylene glycol dimethyl ether, and propylene glycol diethyl ether; esters of glycol monoethers such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, propylene glycol monoethyl ether acetate, propylene glycol monobutyl ether acetate, dipropylene glycol monomethyl ether acetate, dipropylene glycol monoethyl ether acetate, dipropylene glycol monobutyl ether acetate, and 3-methoxybutyl acetate; alkyl esters such as methyl acetate, ethyl acetate, propyl acetate, isopropyl acetate, butyl acetate, methyl propionate, ethyl propionate, butyl propionate, methyl lactate, ethyl lactate, butyl lactate, methyl 3-methoxypropionate, ethyl 3-methoxypropionate, methyl 3-ethoxypropionate, ethyl 3-ethoxypropionate, methyl acetoacetate, and ethyl acetoacetate; ketones such as acetone, methyl ethyl ketone, methyl isobutyl ketone, diisobutyl ketone, cyclopentanone, and cyclohexanone; aromatic hydrocarbons such as benzene, toluene, xylene, and ethylbenzene; aliphatic hydrocarbons such as hexane, cyclohexane, and octane; and amides such as dimethylformamide, dimethylacetamide, and N-methylpyrrolidone.

Examples of the catalysts include phosphorus compounds, inorganic acids such as hydrochloric acid, nitric acid, and sulfuric acid, and organic acids such as formic acid, acetic acid, oxalic acid, citric acid, and propionic acid.

Examples of the phosphorus compounds include phosphorus-containing compounds, which are described below.

In terms of easily promoting the hydrolysis of the trialkoxysilane, a phosphate compound, a phosphinate compound, and a phosphonate compound are preferred, with a phosphate compound and a phosphonate compound being more preferred and a phosphate compound being even more preferred. Examples of the phosphate compound, phosphinate compound, and phosphonate compound are described below. In particular, preferred examples of the phosphorus compounds include triphenylphosphine, phenylphosphonic acid, 2-ethylhexyl phosphate, and diphenyl phosphate.

The synthesis of the polysilsesquioxane may include other steps after the hydrolysis and condensation. Examples of the other steps include aging, deactivation, dilution, concentration, and purification. These steps are preferably performed by known methods.

The amount of the polysilsesquioxane based on 100% by mass of the total solids of the polysilsesquioxane composition is preferably 50 to 99.95% by mass. In terms of further improving the resistance to thermal decomposition and the thermosetting properties, the amount of the polysilsesquioxane based on 100% by mass of the total solids of the polysilsesquioxane composition is more preferably 60% by mass or more, even more preferably 70% by mass or more, while more preferably 99.5% by mass or less, even more preferably 99% by mass or less, further preferably 98% by mass or less.

The polysilsesquioxane composition of the present invention further contains at least one compound selected from the group consisting of phosphorus-containing compounds, triazinethiol compounds, hydroxy group-containing compounds having a boiling point of 230° C. or higher, and carboxy group-containing compounds having a boiling point of 230° C. or higher.

The at least one compound contained functions not only as a condensation catalyst but also as a heat resistance improver, and can improve the resistance to thermal decomposition. In addition, since the resistance to thermal decomposition is improved, curing occurs well at relatively high temperatures, and the adhesion of the obtained cured product to a metal base material can be improved.

### Phosphorus-Containing Compound

In the present invention, the phosphorus-containing compound is at least one compound selected from the group consisting of phosphine compounds, phosphate compounds, phosphinate compounds, and phosphonate compounds.

### Phosphine Compound

The phosphine compounds are represented by the following formula (5), for example:

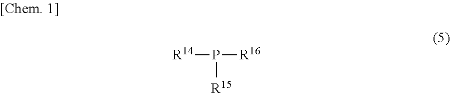

wherein R¹⁴, R¹⁵, and R¹⁶ are the same as or different from each other and each represent a hydrogen atom or an optionally substituted monovalent hydrocarbon group.

The monovalent hydrocarbon group may be acyclic or cyclic. Preferably, it is cyclic in terms of reducing a decrease in the surface hardness of the cured product.

The monovalent hydrocarbon group may be saturated or unsaturated. Preferably, it is unsaturated in terms of reducing a decrease in the surface hardness of the cured product.

Examples of the monovalent hydrocarbon group include alkyl, alkenyl, cycloalkyl, cycloalkenyl, and aryl groups, and a group consisting of two or more of these.

Examples of the alkyl group include the alkyl groups described above.

Examples of the alkenyl group include vinyl, n-propenyl, isopropenyl, 1-butenyl, 2-butenyl, 1-pentenyl, 2-pentenyl, 2-methyl-1-butenyl, 2-methyl-2-butenyl, 3-methyl-1-butenyl, and 1-hexenyl.

Examples of the cycloalkyl group include cyclopropyl, cyclobutyl, cyclopentyl, cyclohexyl, cycloheptyl, 1-methylcyclopropyl, 1-ethylcyclopropyl, and 1-propylcyclopropyl.

Examples of the cycloalkenyl group include cyclopropenyl, cyclobutenyl, cyclopentenyl, cyclopentadienyl, cyclohexenyl, 1,3-cyclohexadienyl, 1,4-cyclohexadienyl, and cycloheptenyl.

Examples of the aryl group include the aryl groups described above.

The monovalent hydrocarbon group is preferably a phenyl group among these.

The monovalent hydrocarbon group preferably has a carbon number of 1 to 12, more preferably 2 to 10, even more preferably 4 to 8.

The monovalent hydrocarbon group may have a substituent, and examples of the substituent include alkyl, alkenyl, alkoxy, amino, alkylamino, and hydroxy groups.

The substituent preferably has a carbon number of 1 to 10, more preferably 1 to 6.

Specific examples of the phosphine compounds include triphenylphosphine, tri-o-tolylphosphine, tri-m-tolylphosphine, tri-p-tolylphosphine, tris-p-methoxyphenylphosphine, diphenylcyclohexylphosphine, tricyclohexylphosphine, tri-n-butylphosphine, tri-t-butylphosphine, tri-n-octylphosphine, dicyclohexylphosphine, diphenylisopropylphosphine, trimethylphosphine, triethylphosphine, tri-n-propylphosphine, tridecylphosphine, and tridodecylphosphine. In terms of reducing a decrease in the transparency of the cured product and a decrease in the surface hardness of the cured product, triphenylphosphine, tris-p-methoxyphenylphosphine, diphenylcyclohexylphosphine, tricyclohexylphosphine, and dicyclohexylphosphine are preferred among these. In terms of easy availability, triphenylphosphine is more preferred.

The phosphine compounds preferably have a boiling point of 100° C. or higher. The phosphine compounds having a boiling point of 100° C. or higher are less likely to volatilize during heating and are thus highly effective as a heat resistance improver. The boiling point of the phosphine compounds is more preferably 150° C. or higher, even more preferably 200° C. or higher.

### Phosphate Compound

The phosphate compounds are represented by the following formula (6), for example:

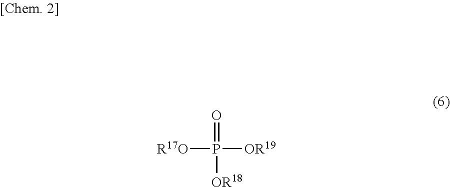

wherein R¹⁷, R¹⁸, and R¹⁹ are the same as or different from each other and each represent a hydrogen atom or an optionally substituted monovalent hydrocarbon group.

Examples of the optionally substituted monovalent hydrocarbon group for R¹⁷, R¹⁸, and R¹⁹ include the groups listed as the optionally substituted monovalent hydrocarbon group for R¹⁴ to R¹⁶ in the formula (5).

In particular, in terms of reducing a decrease in the transparency of the cured product, R¹⁷, R¹⁸, and R¹⁹ each preferably represent an alkyl group or an aryl group. In the case of an alkyl group, an alkyl group having a carbon number of 4 to 12 is more preferred, with an alkyl group having a carbon number of 6 to 8 being even more preferred. In the case of an aryl group, a phenyl group is more preferred.

Specific examples of the phosphate compounds include phosphate triesters, phosphate diesters, and phosphate monoesters.

Examples of the phosphate triesters include trimethyl phosphate, triethyl phosphate, tripropyl phosphate, triisopropyl phosphate, tributyl phosphate, triisobutyl phosphate, triamyl phosphate, trihexyl phosphate, tris (2-ethylhexyl) phosphate, trioctyl phosphate, tridecyl phosphate, tridodecyl phosphate, tricresyl phosphate, triphenyl phosphate, and cresylphenyl phosphate.

Examples of the phosphate diesters include dimethyl phosphate, diethyl phosphate, dipropyl phosphate, diisopropyl phosphate, dibutyl phosphate, diisobutyl phosphate, diamyl phosphate, dihexyl phosphate, di-2-ethylhexyl phosphate, dioctyl phosphate, didecyl phosphate, didodecyl phosphate, and diphenyl phosphate.

Examples of the phosphate monoesters include monomethyl phosphate, monoethyl phosphate, monopropyl phosphate, monoisopropyl phosphate, monobutyl phosphate, monoisobutyl phosphate, monoamyl phosphate, monohexyl phosphate, mono-2-ethylhexyl phosphate, monooctyl phosphate, monodecyl phosphate, monododecyl phosphate, and monophenyl phosphate.

Preferred among these are phosphate diesters and phosphate monoesters because they can be also used as a condensation catalyst in the hydrolysis and condensation of the trialkoxysilane during the preparation of a polysilsesquioxane so that a composition containing a phosphorus-containing compound is easily obtained during the preparation of the polysilsesquioxane.

More preferred among the phosphate diesters are di-2-ethylhexyl phosphate, dioctyl phosphate, and diphenyl phosphate, which are less hydrolyzable.

More preferred among the phosphate monoesters are mono-2-ethylhexyl phosphate, monooctyl phosphate, and monophenyl phosphate.

The phosphate compounds preferably have a thermal decomposition temperature of 100° C. or higher. When the thermal decomposition temperature is within the above range, a decrease in resistance to thermal coloration can be reduced. In terms of reducing a decrease in resistance to thermal coloration, the thermal decomposition temperature of the phosphate compounds is more preferably 150° C. or higher, even more preferably 200° C. or higher. The upper limit of the thermal decomposition temperature of the phosphate compounds is not limited. It is preferably 400° C. or lower in terms of reducing a decrease in resistance to thermal coloration.

The thermal decomposition temperature can be determined by measuring the thermal weight loss using a thermogravimetric analyzer.

### Phosphinate Compound

The phosphinate compounds are represented by the following formula (7), for example:

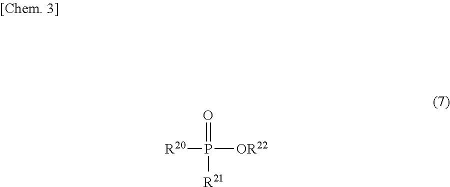

wherein R²⁰, R²¹, and R²² are the same as or different from each other and each represent a hydrogen atom or an optionally substituted monovalent hydrocarbon.

Examples of the optionally substituted monovalent hydrocarbon group for R²⁰, R²¹, and R²² include the groups listed as the optionally substituted monovalent hydrocarbon group for R¹⁴ to R¹⁶ in the formula (5).

In particular, in terms of reducing a decrease in the transparency of the cured product, R²⁰, R²¹, and R²² each preferably represent an alkyl group or an aryl group. In the case of an alkyl group, an alkyl group having a carbon number of 3 to 10 is more preferred, with an alkyl group having a carbon number of 4 to 8 being even more preferred. In the case of an aryl group, a phenyl group is preferred.

Specific examples of the phosphinate compounds include methylphosphinic acid, ethylphosphinic acid, propylphosphinic acid, isopropylphosphinic acid, butylphosphinic acid, isobutylphosphinic acid, amylphosphinic acid, hexylphosphinic acid, 2-ethylhexylphosphinic acid, octylphosphinic acid, decylphosphinic acid, dodecylphosphinic acid, phenylphosphinic acid, tolylphosphinic acid, xylylphosphinic acid, biphenylylphosphinic acid, dimethylphosphinic acid, diethylphosphinic acid, dipropylphosphinic acid, diisopropylphosphinic acid, dibutylphosphinic acid, diisobutylphosphinic acid, diamylphosphinic acid, dihexylphosphinic acid, di-2-ethylhexylphosphinic acid, dioctylphosphinic acid, didecylphosphinic acid, didodecylphosphinic acid, diphenylphosphinic acid, dibiphenylylphosphinic acid, naphthylphosphinic acid, anthrylphosphinic acid, alkyl esters or aryl esters thereof, and metal salts thereof.

In terms of reducing a decrease in the transparency of the cured product and a decrease in the surface hardness of the cured product, hexylphosphinic acid, 2-ethylhexylphosphinic acid, octylphosphinic acid, phenylphosphinic acid, tolylphosphinic acid, and xylylphosphinic acid are preferred, with phenylphosphinic acid, tolylphosphinic acid, and xylylphosphinic acid being more preferred and phenylphosphinic acid being even more preferred.

### Phosphonate Compound

The phosphonate compounds are represented by the following formula (8), for example:

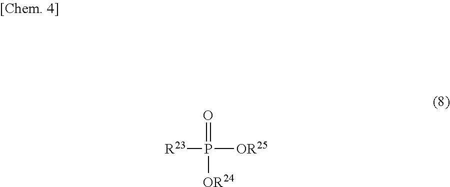

wherein R²³, R²⁴, and R²⁵ are the same as or different from each other and each represent a hydrogen atom or an optionally substituted monovalent hydrocarbon.

Examples of the optionally substituted monovalent hydrocarbon group for R²³, R²⁴, and R²⁵ include the groups listed as the optionally substituted monovalent hydrocarbon group for R¹⁴ to R¹⁶ in the formula (5).

In particular, R²³, R²⁴, and R²⁵ each preferably represent a hydrogen atom, an alkyl group, or an aryl group in terms of reducing a decrease in the transparency of the cured product. In the case of an alkyl group, an alkyl group having a carbon number of 4 to 12 is more preferred, with an alkyl group having a carbon number of 6 to 8 being even more preferred. In the case of an aryl group, a phenyl group is more preferred.

Specific examples of the phosphonate compounds include dimethyl phosphonate, diethyl phosphonate, diphenyl phosphonate, dimethylmethyl phosphonate, dipropyl phosphonate, diisopropyl phosphonate, dibutyl phosphonate, isobutyl phosphonate, diamyl phosphonate, dihexyl phosphonate, di-2-ethylhexyl phosphonate, dioctyl phosphonate, didecyl phosphonate, didodecyl phosphonate, methylphosphonic acid, ethylphosphonic acid, propylphosphonic acid, isopropylphosphonic acid, butylphosphonic acid, isobutylphosphonic acid, amylphosphonic acid, hexylphosphonic acid, 2-ethylhexylphosphonic acid, octylphosphonic acid, decylphosphonic acid, dodecylphosphonic acid, phenylphosphonic acid, benzylphosphonic acid, tolylphosphonic acid, xylylphosphonic acid, biphenylphosphonic acid, naphthylphosphonic acid, anthrylphosphonic acid, and alkyl esters or aryl esters thereof. In terms of reducing a decrease in the transparency of the cured product, the alkyl group of the alkyl ester preferably has a carbon number of 1 to 3, and the aryl ester is preferably a phenyl group.

In terms of reducing a decrease in the transparency of the cured product, hexylphosphonic acid, 2-ethylhexylphosphonic acid, octylphosphonic acid, decylphosphonic acid, phenylphosphonic acid, benzylphosphonic acid, and tolylphosphonic acid are preferred, with 2-ethylhexylphosphonic acid, octylphosphonic acid, and phenylphosphonic acid being more preferred and phenylphosphonic acid being even more preferred.

In terms of providing better resistance to thermal decomposition to the polysilsesquioxane composition, the phosphorus-containing compound is preferably a phosphate compound, a phosphinate compound, or a phosphonate compound, more preferably a phosphate compound or a phosphonate compound, even more preferably a phosphate compound among these.

The polysilsesquioxane composition may contain one or more of the above-described phosphorus-containing compounds.

### Triazine Thiol Compound

Examples of the triazinethiol compounds include 1,3,5-triazine-2,4,6-trithiol, 2-(dibutylamino)-1,3,5-triazine-4,6-dithiol (also known as “6-(dibutylamino)-1,3,5-triazine-2,4-dithiol”), 6-diallylamino-1,3,5-triazine-2,4-dithiol, 6-(4-vinylbenzyl-n-propyl)amino-1,3,5-triazine-2,4-dithiol, 6-(diisopropylamino)-1,3,5-triazine-2,4-dithiol, 6-(diisobutylamino)-1,3,5-triazine-2,4-dithiol, 6-di(2-ethylhexyl)amino-1,3,5-triazine-2,4-dithiol, 6-(allylamino)-1,3,5-triazine-2,4-dithiol, 6-(diethylamino)-1,3,5-triazine-2,4-dithiol, 6-(butylamino)-1,3,5-triazine-2,4-dithiol, 6-(hexylamino)-1,3,5-triazine-2,4-dithiol, 6-(cyclohexylamino)-1,3,5-triazine-2,4-dithiol, 6-(phenylamino)-1,3,5-triazine-2,4-dithiol, and 6-(anilino)-1,3,5-triazine-2,4-dithiol. In terms of high affinity with polysilsesquioxanes, dithiols are preferred, with 6-(diisopropylamino)-1,3,5-triazine-2,4-dithiol and 6-(dibutylamino)-1,3,5-triazine-2,4-dithiol being more preferred among these.

### Hydroxy Group-Containing Compound Having Boiling Point of 230° C. or Higher

Examples of the hydroxy group-containing compound having a boiling point of 230° C. or higher include carbon number C10-C18 alkyl alcohols having a boiling point of 230° C. or higher, alicyclic alcohols having a boiling point of 230° C. or higher, aromatic alcohols having a boiling point of 230° C. or higher, and compounds having a boiling point of 230° C. or higher in which hydroxy groups are directly bonded to aromatic rings. Here, the hydroxy group-containing compound having a boiling point of 230° C. or higher does not include a hindered phenolic antioxidant, which is described below.

In terms of high affinity with polysilsesquioxanes, the hydroxy group-containing compound is preferably monohydroxy, with 1-naphthol, 2-naphthol, 4-phenylbenzyl alcohol, 2-phenylphenol, 3-phenylphenol, 4-phenylphenol, and N,N-dimethylaminophenol being more preferred among these.

### Carboxy Group-Containing Compound Having Boiling Point of 230° C. or Higher

Examples of the carboxy group-containing compound having a boiling point of 230° C. or higher include carbon number C8-C18 alkylcarboxylic acids having a boiling point of 230° C. or higher, alicyclic carboxylic acids having a boiling point of 230° C. or higher, and aromatic carboxylic acids having a boiling point of 230° C. or higher.

In terms of high affinity with polysilsesquioxanes, the carboxy group-containing compound is preferably a monocarboxylic acid, with cyclohexanecarboxylic acid, benzoic acid, 3-phenylbenzoic acid, 4-phenylbenzoic acid, 1-naphthoic acid, and 2-naphthoic acid being more preferred among these.

The polysilsesquioxane composition may contain one or more compounds selected from the phosphorus-containing compound, triazinethiol compound, hydroxy group-containing compound having a boiling point of 230° C. or higher, and carboxy group-containing compound having a boiling point of 230° C. or higher.

The total amount of the phosphorus-containing compound, triazinethiol compound, hydroxy group-containing compound having a boiling point of 230° C. or higher, and carboxy group-containing compound having a boiling point of 230° C. or higher is 0.05 to 50% by mass based on 100% by mass of the total solids of the polysilsesquioxane composition. In terms of improving the heat resistance of the cured product, the amount of the compound(s) based on 100% by mass of the total solids of the polysilsesquioxane composition is more preferably 0.1% by mass or more, even more preferably 0.5% by mass or more, further preferably 1% by mass or more, while more preferably 20% by mass or less, even more preferably 15% by mass or less, further preferably 10% by mass or less.

The total amount of the phosphorus-containing compound, triazinethiol compound, hydroxy group-containing compound, and carboxy group-containing compound is more preferably 0.1 to 20% by mass, even more preferably 0.5 to 15% by mass, further preferably 1 to 10% by mass, based on 100% by mass of the total solids of the polysilsesquioxane composition.

### Hindered Phenolic Antioxidant

The polysilsesquioxane composition of the present invention preferably further contains a hindered phenolic antioxidant. The presence of a hindered phenolic antioxidant can improve resistance to cracking caused by heat (resistance to thermal cracking).

The hindered phenolic antioxidant is a phenolic compound which contains at least one phenolic hydroxy group and in which one or both of the two carbon atoms adjacent to the carbon atom having the phenolic hydroxy group have a sterically hindered substituent. The sterically hindered substituent means a bulky substituent such as a branched or cyclic alkyl group having a carbon number of four or more (e.g., a t-butyl group).

Examples of the hindered phenolic antioxidant include 1,3,5-tris[[3,5-bis(1,1-dimethylethyl)-4-hydroxyphenyl]methyl]-1,3,5-triazine-2,4,6(1H,3H,5H)-trione (ADEKA, trade name: ADK STAB AO-20), 1,1,3-tris(2-methyl-4-hydroxy-5-tert-butylphenyl)butane (ADEKA, trade name: ADK STAB AO-30), 4,4′-butylidenebis(6-tert-butyl-m-cresol) (ADEKA, trade name: ADK STAB AO-40), 3-(3,5-di-tert-butyl-4-hydroxyphenyl)stearyl propionate (ADEKA, trade name: ADK STAB AO-50), pentaerythritol tetrakis[3-(3,5-di-tert-butyl-4-hydroxyphenyl)propionate] (ADEKA, trade name: ADK STAB AO-60), 2,2′-dimethyl-2,2′-(2,4,8,10-tetraoxaspiro[5.5]undecane-3,9-diyl)dipropane-1,1′-diyl=bis[3-(3-tert-butyl-4-hydroxy-5-methylphenyl)propynoate] (ADEKA, trade name: ADK STAB AO-80), and 2,4,6-tris(3′,5′-di-tert-butyl-4′-hydroxybenzyl)mesitylene (ADEKA, trade name: ADK STAB AO-330).

Preferred among these are hindered phenolic antioxidants having a 1% weight loss temperature in a nitrogen atmosphere of 300° C. or higher, such as 1,3,5-tris[[3,5-bis(1,1-dimethylethyl)-4-hydroxyphenyl]methyl]-1,3,5-triazine-2,4,6(1H,3H,5H)-trione (ADEKA, trade name: ADK STAB AO-20), 2,2′-dimethyl-2,2′-(2,4,8,10-tetraoxaspiro [5.5]undecane-3,9-diyl)dipropane-1,1′-diyl=bis[3-(3-tert-butyl-4-hydroxy-5-methylphenyl)propynoate] (ADEKA, trade name: ADK STAB AO-80), pentaerythritol tetrakis[3-(3,5-di-tert-butyl-4-hydroxyphenyl)propionate] (ADEKA, trade name: ADK STAB AO-60), and 2,4,6-tris(3′,5′-di-tert-butyl-4′-hydroxybenzyl)mesitylene (ADEKA, trade name: ADK STAB AO-330). More preferred are 1,3,5-tris[[3,5-bis(1,1-dimethylethyl)-4-hydroxyphenyl]methyl]-1,3,5-triazine-2,4,6(1H,3H,5H)-trione (ADEKA, trade name: ADK STAB AO-20) and 2,2′-dimethyl-2,2′-(2,4,8,10-tetraoxaspiro[5.5]undecane-3,9-diyl)dipropane-1,1′-diyl=bis[3-(3-tert-butyl-4-hydroxy-5-methylphenyl)propynoate] (ADEKA, trade name: ADK STAB AO-80).

The amount of the hindered phenolic antioxidant is preferably 0.01 to 10% by mass, more preferably 0.1 to 5% by mass, even more preferably 0.3 to 2% by mass, based on 100% by mass of the total solids of the polysilsesquioxane composition.

### Other Components

The polysilsesquioxane composition of the present invention may further contain other components in addition to the components described above within a range that does not affect the effects of the present invention. Examples of the other components include solvents; color materials (pigments, dyes); dispersants; heat resistance improvers; leveling agents; inorganic fine particles such as silica, titanium, or zirconia fine particles; organic fine particles such as acrylic, polystyrene, or polyolefin fine particles; coupling agents such as silane, aluminum, or titanium coupling agents; fillers; resins; plasticizers; polymerization initiators; thermosetting agents; polymerization inhibitors; ultraviolet absorbers; antioxidants other than hindered phenolic antioxidants; matting agents; antifoaming agents; antistatic agents; slip agents; surface modifiers; rocking agents; polymerizable compounds; and acid generators. Each of these may be used alone or in combination of two or more. These components may be appropriately selected from known ones for use, and the amounts thereof to be used can also be set as appropriate.

### Preparation of Polysilsesquioxane Composition

The polysilsesquioxane composition of the present invention can be prepared by mixing the polysilsesquioxane, at least one compound selected from the group consisting of the phosphorus-containing compound, triazinethiol compound, hydroxy group-containing compound having a boiling point of 230° C. or higher, and carboxy group-containing compound having a boiling point of 230° C. or higher, and other optional components. The mixing may be performed by any method. An example thereof is a method of mixing and dispersing the components described above using a known mixer or disperser.

### Cured Product

A method for preparing a cured product using the polysilsesquioxane composition of the present invention is not limited, and a known method may be used. An example of the method is a method including applying the polysilsesquioxane composition to a base material and curing the coating by heating, exposure to active energy rays such as ultraviolet rays, or a combination of these to prepare a cured product.

The material of the base material (substrate) is not limited, and may be appropriately selected according to the purposes and uses. For example, it may be an inorganic substance, an organic substance, a mixture thereof, or an organic-inorganic composite. Preferred among these is an inorganic substance.

Examples of the inorganic substance include metals and glass. Metal-containing compounds are preferred.

Examples of the metal-containing compounds include metals and compounds containing metals, and specifically include metals, metal oxides, metal nitrides, and metal carbides.

Preferred examples of the metals include silicon wafer, copper, aluminum, and stainless steel (SUS).

Preferred examples of the metal oxides include silica, titania, tin-doped indium oxide (ITO), and indium zinc oxide (IZO).

Preferred examples of the metal nitrides include silicon nitride.

The organic substance may be a conventionally known resin.

The base material is preferably a plate-shaped base material, particularly preferably a plate-shaped base material made of any of the preferred materials described above.

Non-limiting examples of a method of applying the polysilsesquioxane composition to form a coating include known methods such as spin coating, gravure coating, dip coating, slot die coating, and spray coating.

The heating is preferably performed by a known method. The heating temperature is not limited and may be appropriately selected according to the formulation of the polysilsesquioxane composition. It is usually 50° C. to 500° C., preferably 80° C. to 450° C., more preferably 100° C. to 400° C.

The exposure to active energy rays may be performed by any known method capable of exposing the coating to radiation such as visible rays, ultraviolet rays, far ultraviolet rays, electron beams, or X-rays. For example, a lamp source or a laser source may be used. Examples of the lamp source include a xenon lamp, a halogen lamp, a tungsten lamp, a high-pressure mercury lamp, an ultra-high-pressure mercury lamp, a metal halide lamp, a medium-pressure mercury lamp, a low-pressure mercury lamp, a carbon arc lamp, and a fluorescent lamp. Examples of the laser source include an argon ion laser, a YAG laser, an excimer laser, a nitrogen laser, a helium-cadmium laser, and a semiconductor laser.

When the cured product is a cured film, the film thickness thereof is preferably 1 to 1000 μm, more preferably 5 to 200 μm, even more preferably 10 to 100 μm.

The cured product thus obtained has excellent resistance to thermal decomposition and excellent adhesion to metal base materials.

Examples of the metal base materials include base materials made of any of the metal-containing compounds described above. The metal base materials are preferably made of metal and/or a metal oxide, more preferably made of metal.

The present invention encompasses such a cured product obtained by curing the polysilsesquioxane composition.

### Uses

The polysilsesquioxane composition of the present invention can provide a cured product having excellent resistance to thermal decomposition and excellent adhesion to metal base materials. Furthermore, using a specific polysilsesquioxane allows the cured product to have excellent transparency and excellent flexibility. Thus, the polysilsesquioxane composition of the present invention is suitable for uses requiring resistance to thermal decomposition and adhesion to metal base materials and for uses requiring transparency and flexibility. Examples of such uses include various uses including optical materials (components), materials of machine components, materials of electric/electronic components, materials of automobile components, materials for civil engineering and construction, molding materials, and materials of paints and adhesives. The polysilsesquioxane composition of the present invention is preferably used for optical materials or low dielectric materials.

The polysilsesquioxane composition of the present invention is specifically used for, for example, optical uses such as camera imaging lenses, LED encapsulants, optical adhesives, bonding materials for optical transmission, filters, diffraction gratings, prisms, optical guides, transparent glass and cover glass such as watch glasses and cover glasses for display devices; optical device uses such as photosensors, photoswitches, LEDs, light-emitting elements, optical waveguides, multiplexers, demultiplexers, disconnectors, optical splitters, and optical fiber adhesives; display device uses such as substrates for display elements (e.g., LCDs, organic ELs, and PDPs), color filter substrates, touch panel substrates, display protective films, display backlights, light guide plates, antireflection films, and antifogging films; and insulating films.

### EXAMPLES

The present invention is described in more detail below with reference to examples, but the present invention is not limited to these examples. It should be noted that the terms “part(s)” and “%” refer to “part(s) by mass” and “% by mass”, respectively, unless otherwise stated.

In the following synthesis examples and the like, various physical properties were evaluated in the following ways.

### Weight Average Molecular Weight

The weight average molecular weight was measured using HLC-8320GPC (Tosoh Corporation) and a TSKgel SuperHZ-N column (Tosoh Corporation) by gel permeation chromatography (GPC). Polystyrene was used as a standard substance, and tetrahydrofuran was used as an eluent.

### Solid Content

About 1 g of a resin solution was weighed in an aluminum cup and about 3 g of acetone was added thereto for dissolution, followed by natural drying at room temperature. The resulting substance was dried using a vacuum dryer (Tokyo Rikakikai Co., Ltd., trade name: VOS-301SD) under vacuum at 200° C. for one hour, and was allowed to cool in a desiccator. The mass of the dried substance was measured. The weight loss was obtained from the resulting mass, and the solid content (% by mass) of the polymer solution was calculated therefrom.

### T-Structure [R¹SiO_{1.5}] and [CH₃CH₃SiO_{1.0}]

About 0.3 g of a resin solution was weighed in a screw-cap tube and about 0.8 g of dimethyl sulfoxide-d6 was added thereto for dissolution. The resulting solution was transferred to an NMR tube and subjected to ²⁹Si-NMR analysis (JNM-ECZ600 available from JEOL). The amount (mol %) of the T-structure [R¹SiO_{1.5}] was determined as follows: the areas of the peaks of the T-structure [R¹SiO_{1.5}], D-structure [R²R³SiO_{1.0}] (e.g., [R²SiO_{1.0}(OR⁴)]), M-structure [R⁵R⁶R⁷SiO_{0.5}] (e.g., [R⁵SiO_{0.5}(OR⁸)₂]), and monomer were determined and the ratio of the area of the T-structure to the sum of the areas was calculated. Specifically, in the case of a polysilsesquioxane obtained by hydrolyzing and condensing phenyltrimethoxysilane and methyltriethoxysilane, a sample of a homopolymer obtained by hydrolyzing and condensing phenyltrimethoxysilane, a sample of a homopolymer obtained by hydrolyzing and condensing methyltriethoxysilane, a sample of phenyltrimethoxysilane, and a sample of methyltriethoxysilane were subjected to ²⁹Si-NMR analysis. For phenyltrimethoxysilane, the peak of the T-structure, the peak of the D-structure, the peak of the M-structure, and the peak of the monomer appeared at −76 to −81 ppm, −67 to −72 ppm, −60 to −63 ppm, and −55 ppm, respectively. For methyltriethoxysilane, the peak of the T-structure, the peak of the D-structure, the peak of the M-structure, and the peak of the monomer appeared at −63 to −68 ppm, −50 to −58 ppm, −47 ppm, and −38 ppm, respectively. The areas of the respective peaks were determined, and the amount (mol %) of the T-structure was calculated from the ratio of the area of the T-structure to the sum of the areas.

For other polysilsesquioxanes, the peaks of the T-structure, D-structure, M-structure, and monomer were identified in the same manner, the areas of the peaks were determined, and the amount of the T-structure was determined.

In Examples 20 to 23, the amount of [CH₃CH₃SiO_{1.0}] was also determined in the same manner. Specifically, in the case of the polysilsesquioxane of Example 20 obtained by hydrolyzing and condensing phenyltrimethoxysilane, methyltriethoxysilane, and dimethyldiethoxysilane, the peaks of the T-structure, D-structure, M-structure, and monomer of the polysilsesquioxane of phenyltrimethoxysilane and methyltriethoxysilane were observed as described above. For dimethyldiethoxysilane, a sample of a homopolymer obtained by hydrolyzing and condensing dimethyltriethoxysilane and a sample of dimethyldiethoxysilane were subjected to ²⁹Si-NMR analysis. The peak of the D-structure [CH₃CH₃SiO_{1.0}], the peak of the M-structure, and the peak of the monomer appeared at −19 to −22 ppm, −16 to −19 ppm, and −3 to −4 ppm, respectively. The areas of the respective peaks were determined, and the amount (mol %) of [CH₃CH₃SiO_{1.0}] was calculated from the ratio of the area of [CH₃CH₃SiO_{1.0}] to the sum of the areas.

### Resistance to Thermal Decomposition (Thermal Weight Loss (%))

About 30 mg of a resin solution was weighed in an aluminum pan, heated by increasing the temperature from room temperature to 200° C. at a rate of 20° C./min using TGA-50/50H (Shimadzu Corporation), allowed to stand at 200° C. for one hour, heated by increasing the temperature from 200° C. to 400° C. at a rate of 10° C./min, and allowed to stand at 400° C. for three hours. Then, the thermal weight loss (%) was determined as follows: the weight loss between the end of allowing to stand at 200° C. for one hour and the end of allowing to stand at 400° C. for three hours was determined, and the percentage (%) of the resulting weight loss to the resin weight after allowing to stand at 200° C. for one hour was calculated.

### Adhesion

A resin solution was spin-coated on a copper plate (0.5×50×100 mm, available from Nippon Testpanel Co., Ltd.), dried at 100° C. for 30 minutes, followed by drying at 200° C. for one hour. Thus, a coating having a thickness of 20 μm was formed. Thereafter, the obtained coating was heat-treated at 200° C. for 500 hours. A coating not peeled from the copper plate after heating at 200° C. for 500 hours was rated as “o (good)”. A coating peeled from the copper plate after heating at 200° C. for 500 hours, but not peeled from the copper plate after heating at 200° C. for 300 hours was rated as “Δ (fair)”. A coating peeled from the copper plate after heating at 200° C. for 300 hours was rated as “x (poor)”.

### Transparency

A resin solution was spin-coated on a 5-cm-square glass substrate, dried at 100° C. for 30 minutes, followed by drying at 200° C. for one hour. Thus, a coating having a thickness of 25 μm was formed. The coating was visually evaluated. A clear (transparent) coating without haze (cloudiness) was rated as “o (good)”, and a coating with haze was rated as “x (poor)”.

### Bending Test

A resin solution was spin-coated on a copper plate, dried at 100° C. for 30 minutes, followed by drying at 200° C. for one hour. Thus, a coating having a thickness of 20 μm was formed. Thereafter, the workpiece was bent using a paint film bending tester No. 514 (Yasuda Seiki Seisakusho, Ltd. Φ4 mm) with the coating on the copper plate being on the outside until the angle formed by the copper plate reached about 90 degrees. The conditions of the coating were observed. A coating with neither peeling nor cracks when the angle was about 90 degrees was rated as “o (good)”. A coating with peeling or cracks when the angle was about 90 degrees, but with neither peeling nor cracks when the angle was about 45 degrees was rated as “Δ (fair)”. A coating with peeling or cracks when the angle was about 45 degrees was rated as “x (poor)”.

### Resistance to Thermal Cracking

A polysilsesquioxane composition was applied to a silicon wafer, dried at 100° C. for 30 minutes, followed by drying at 250° C. for one hour. Thus, a coating having a thickness of 20 μm was formed. The obtained coating was heat-treated at 400° C. in a nitrogen atmosphere. A coating with cracks after one-hour heat treatment was rated as “x (poor)”. A coating with cracks after two-hour heat treatment was rated as “Δ (fair)”. A coating with no cracks even after two-hour heat treatment was rated as “o (good)”.

### Synthesis Example 1

A reaction vessel was charged with 55.7 parts of diethylene glycol ethyl methyl ether, 100 parts of phenyltrimethoxysilane, and 29.97 parts of methyltriethoxysilane and purged with nitrogen. While the contents were stirred, 54.53 parts of water was added thereto. The temperature was increased to 80° C. Thereafter, the temperature was increased from 80° C. to 160° C. at a rate of 10° C./hour while diethylene glycol ethyl methyl ether and water were distilled off. After the temperature reached 160° C., the reaction was performed at 160° C. for 12 hours to obtain a resin solution (polysilsesquioxane solution) 1. Table 1 shows the physical properties of the obtained resin solution.

### Synthesis Examples 2 to 4

The reaction was performed as in Synthesis Example 1 except that the type of the trialkoxysilane compound used was changed and the formulation of the materials was changed as shown in Table 1. Thus, resin solutions 2 to 4 were prepared.

### Synthesis Example 5

A reaction vessel was charged with 55.7 parts of diethylene glycol ethyl methyl ether, 100 parts of phenyltrimethoxysilane, and 29.97 parts of methyltriethoxysilane and purged with nitrogen. While the contents were stirred, 54.53 parts of water and 0.26 parts of 2-ethylhexyl phosphate (mixture of mono- and diesters, available from Tokyo Chemical Industry Co., Ltd.) were added thereto. The temperature was increased to 80° C. Thereafter, the temperature was increased from 80° C. to 160° C. at a rate of 10° C./hour while diethylene glycol ethyl methyl ether and water were distilled off. After the temperature reached 160° C., the reaction was performed at 160° C. for 12 hours to obtain a resin solution 5.

### Synthesis Examples 6 to 15 and 17 to 23

The reaction was performed as in Synthesis Example 5 except that the type or amount of the trialkoxysilane compound or the phosphorus compound used was changed as shown in Table 1. Thus, resin solutions 6 to 15 and 17 to 23 were prepared.

### Synthesis Example 16

A reaction vessel was charged with 46.47 parts of diethylene glycol ethyl methyl ether, 110 parts of phenyltrimethoxysilane, 66.28 parts of n-propyltrimethoxysilane, and 9.6 parts of vinyltriethoxysilane. The contents were bubbled with an oxygen/nitrogen (7/93 (v/v)) gas mixture. While the contents were stirred, 0.06 parts of topanol (6-tert-butyl-2,4-xylenol), 54.53 parts of water, and 0.37 parts of 2-ethylhexyl phosphate (mixture of mono- and diesters) were added thereto. The temperature was increased to 80° C. Thereafter, the temperature was increased from 80° C. to 140° C. at a rate of 10° C./hour while diethylene glycol ethyl methyl ether and water were distilled off. After the temperature reached 140° C., the reaction was performed at 140° C. for 10 hours to obtain a resin solution 16.

### Example 1

To the resin solution 1 in an amount of 100 parts was added 0.6 parts of triphenylphosphine as an additive to prepare a polysilsesquioxane composition. The obtained polysilsesquioxane composition was subjected to evaluations of resistance to thermal decomposition, adhesion, transparency, and bending test. Table 2 shows the evaluation results.

### Examples 2 to 49 and Comparative Examples 1 to 7

Resin solutions and additives were blended as shown in Tables 2 to 4, and the same evaluations as in Example 1 were performed. The compositions of Examples 27 to 49 and Comparative Examples 5 to 7 were also subjected to evaluation of resistance to thermal cracking. Tables 2 to 4 show the evaluation results. The evaluation of the transparency and the bending test of the composition of Comparative Example 4 was failed because the coating peeled from the substrate before evaluation.

The boiling points of the phosphine compounds in Tables 2 and 3 are as follows.
Triphenylphosphine (boiling point 360° C.)
Trioctylphosphine (boiling point 240° C.)

TABLE 1

| | | Synthesis Example | | | | | |
|---|---|---|---|---|---|---|---|
| | | 1 | 2 | 3 | 4 | 5 | 6 |
| | | Resin solution | | | | | |
| | | 1 | 2 | 3 | 4 | 5 | 6 |
| Formulation | Diethylene glycol | 55.7 | 55.7 | 55.7 | 55.42 | 55.7 | 55.7 |
| (parts) | ethyl methyl ether | | | | | | |
| | Phenyltrimethoxysilane | 100 | 100 | 100 | 100 | 100 | 100 |
| | Methyltriethoxysilane | 29.97 | — | — | 21.58 | 29.97 | 29.97 |
| | n-Propyltrimethoxysilane | — | 29.97 | — | 7.73 | — | — |
| | i-Butyltrimethoxysilane | — | — | — | — | — | — |
| | n-Hexyltrimethoxysilane | — | — | — | — | — | — |
| | n-Octyltriethoxysilane | — | — | — | — | — | — |
| | n-Decyltrimethoxysilane | — | — | 29.97 | — | — | — |
| | Vinyltriethoxysilane | — | — | — | — | — | — |
| | Dimethyldiethoxysilane | — | — | — | — | — | — |
| | Water | 54.53 | 54.53 | 54.53 | 54.53 | 54.53 | 54.53 |
| | 2-Ethylhexyl phosphate | — | — | — | — | 0.26 | — |
| | (mixture of mono- and diesters) | | | | | | |
| | Diphenyl phosphate | — | — | — | — | — | 0.26 |
| | Triphenylphosphine | — | — | — | — | — | — |
| | Phenylphosphinic acid | — | — | — | — | — | — |
| | Phenylphosphonic acid | — | — | — | — | — | — |
| Physical | T-structure, [R¹SiO_{1.5}] (mol %) | 60 | 65 | 50 | 50 | 65 | 65 |
| properties | [CH₃CH₃SiO_{1.0}] (mol %) | — | — | — | — | — | — |
| | Solid content (%) | 61 | 61 | 58 | 61 | 61 | 61 |
| | Weight-average molecular weight | 15000 | 8000 | 5000 | 11000 | 12000 | 12000 |

| | | Synthesis Example | | | | |
|---|---|---|---|---|---|---|
| | | 7 | 8 | 9 | 10 | 11 |
| | | Resin solution | | | | |
| | | 7 | 8 | 9 | 10 | 11 |
| Formulation | Diethylene glycol | 55.7 | 55.7 | 55.7 | 55.42 | 55.42 |
| (parts) | ethyl methyl ether | | | | | |
| | Phenyltrimethoxysilane | 100 | 100 | 100 | 100 | 66.67 |
| | Methyltriethoxysilane | 29.97 | 29.97 | 29.97 | 21.58 | 17.98 |
| | n-Propyltrimethoxysilane | — | — | — | 7.73 | 38.66 |
| | i-Butyltrimethoxysilane | — | — | — | — | — |
| | n-Hexyltrimethoxysilane | — | — | — | — | — |
| | n-Octyltriethoxysilane | — | — | — | — | — |
| | n-Decyltrimethoxysilane | — | — | — | — | — |
| | Vinyltriethoxysilane | — | — | — | — | — |
| | Dimethyldiethoxysilane | — | — | — | — | — |
| | Water | 54.53 | 54.53 | 54.53 | 54.53 | 54.53 |
| | 2-Ethylhexyl phosphate | — | — | — | 0.26 | 0.26 |
| | (mixture of mono- and diesters) | | | | | |
| | Diphenyl phosphate | — | — | — | — | — |
| | Triphenylphosphine | 1.3 | — | — | — | — |
| | Phenylphosphinic acid | — | 0.26 | — | — | — |
| | Phenylphosphonic acid | — | — | 0.26 | — | — |
| Physical | T-structure, [R¹SiO_{1.5}] (mol %) | 65 | 65 | 65 | 65 | 55 |
| properties | [CH₃CH₃SiO_{1.0}] (mol %) | — | — | — | — | — |
| | Solid content (%) | 62 | 61 | 61 | 61 | 61 |
| | Weight-average molecular weight | 13000 | 12000 | 12000 | 9000 | 9000 |

| | | Synthesis Example | | | | | |
|---|---|---|---|---|---|---|---|
| | | 12 | 13 | 14 | 15 | 16 | 17 |
| | | Resin solution | | | | | |
| | | 12 | 13 | 14 | 15 | 16 | 17 |
| Formulation | Diethylene glycol | 55.42 | 55.42 | 55.42 | 55.42 | 46.47 | 35.38 |
| (parts) | ethyl methyl ether | | | | | | |
| | Phenyltrimethoxysilane | 100 | 100 | 100 | 100 | 110 | 100 |
| | Methyltriethoxysilane | 21.58 | 21.58 | 21.58 | 21.58 | — | 19.27 |
| | n-Propyltrimethoxysilane | — | — | — | — | 66.28 | — |
| | i-Butyltrimethoxysilane | 7.73 | — | — | — | — | — |
| | n-Hexyltrimethoxysilane | — | 7.73 | — | — | — | 22.30 |
| | n-Octyltriethoxysilane | — | — | 7.73 | — | — | — |
| | n-Decyltrimethoxysilane | — | — | — | 7.73 | — | — |
| | Vinyltriethoxysilane | — | — | — | — | 9.6 | — |
| | Dimethyldiethoxysilane | — | — | — | — | — | — |
| | Water | 54.53 | 54.53 | 54.53 | 54.53 | 54.53 | 38.95 |
| | 2-Ethylhexyl phosphate | 0.26 | 0.26 | 0.26 | 0.26 | 0.37 | 0.28 |
| | (mixture of mono- and diesters) | | | | | | |
| | Diphenyl phosphate | — | — | — | — | — | — |
| | Triphenylphosphine | — | — | — | — | — | — |
| | Phenylphosphinic acid | — | — | — | — | — | — |
| | Phenylphosphonic acid | — | — | — | — | — | — |
| Physical | T-structure, [R¹SiO_{1.5}] (mol %) | 60 | 50 | 45 | 40 | 50 | 60 |
| properties | [CH₃CH₃SiO_{1.0}] (mol %) | — | — | — | — | — | — |
| | Solid content (%) | 61 | 60 | 59 | 59 | 71 | 71 |
| | Weight-average molecular weight | 9000 | 9000 | 8000 | 7000 | 9000 | 11000 |

| | | Synthesis Example | | | | | |
|---|---|---|---|---|---|---|---|
| | | 18 | 19 | 20 | 21 | 22 | 23 |
| | | Resin solution | | | | | |
| | | 18 | 19 | 20 | 21 | 22 | 23 |
| Formulation | Diethylene glycol | 37.29 | 36.91 | 23.68 | 24.04 | 24.93 | 24.75 |
| (parts) | ethyl methyl ether | | | | | | |
| | Phenyltrimethoxysilane | 100 | 100 | 100 | 100 | 100 | 100 |
| | Methyltriethoxysilane | 19.27 | 19.27 | 12.85 | — | — | — |
| | n-Propyltrimethoxysilane | — | — | — | — | — | — |
| | i-Butyltrimethoxysilane | — | — | — | — | — | — |
| | n-Hexyltrimethoxysilane | — | — | — | 14.87 | — | — |
| | n-Octyltriethoxysilane | 29.88 | — | — | — | 19.92 | — |
| | n-Decyltrimethoxysilane | — | 28.36 | — | — | — | 18.91 |
| | Vinyltriethoxysilane | — | — | — | — | — | — |
| | Dimethyldiethoxysilane | — | — | 21.37 | 21.37 | 21.37 | 21.37 |
| | Water | 38.95 | 38.95 | 36.35 | 36.35 | 36.35 | 36.35 |
| | 2-Ethylhexyl phosphate | 0.30 | 0.30 | 0.27 | 0.27 | 0.28 | 0.28 |
| | (mixture of mono- and diesters) | | | | | | |
| | Diphenyl phosphate | — | — | — | — | — | — |
| | Triphenylphosphine | — | — | — | — | — | — |
| | Phenylphosphinic acid | — | — | — | — | — | — |
| | Phenylphosphonic acid | — | — | — | — | — | — |
| Physical | T-structure, [R¹SiO_{1.5}] (mol %) | 60 | 60 | 40 | 45 | 45 | 45 |
| properties | [CH₃CH₃SiO_{1.0}] (mol %) | — | — | 20 | 20 | 20 | 20 |
| | Solid content (%) | 71 | 71 | 81 | 81 | 81 | 81 |
| | Weight-average molecular weight | 10000 | 9000 | 10000 | 8000 | 7000 | 6000 |

TABLE 2

| | | Example | | | | | | | | | | | | | | |
|---|---|---|---|---|---|---|---|---|---|---|---|---|---|---|---|---|
| | | 1 | 2 | 3 | 4 | 5 | 6 | 7 | 8 | 9 | 10 | 11 | 12 | 13 | 14 | 15 |
| Resin solution No. | | 1 | 1 | 1 | 1 | 1 | 1 | 1 | 1 | 2 | 3 | 4 | 4 | 5 | 6 | 7 |
| (parts) | | 100 | 100 | 100 | 100 | 100 | 100 | 100 | 100 | 100 | 100 | 100 | 100 | 100 | 100 | 100 |
| Additive | Triphenylphosphine | 0.6 | — | — | — | — | — | — | — | 0.6 | 0.6 | 0.6 | — | — | — | — |
| (parts) | Trioctylphosphine | — | 0.6 | — | — | — | — | — | — | — | — | — | — | — | — | — |
| | Phenylphosphinic acid | — | — | 0.6 | — | — | — | — | — | — | — | — | — | — | — | — |
| | Methyl phosphate | — | — | — | 0.6 | — | — | — | — | — | — | — | — | — | — | — |
| | (mixture of mono- | | | | | | | | | | | | | | | |
| | and diesters) | | | | | | | | | | | | | | | |
| | 2-Ethylhexyl phosphate | — | — | — | — | 0.6 | — | — | — | — | — | — | 0.6 | 0.6 | — | — |
| | (mixture of mono- | | | | | | | | | | | | | | | |
| | and diesters) | | | | | | | | | | | | | | | |
| | Dibutyl phosphate | — | — | — | — | — | 0.6 | — | — | — | — | — | — | — | — | — |
| | Diphenyl phosphate | — | — | — | — | — | — | 0.6 | — | — | — | — | — | — | 0.6 | — |
| | Phenylphosphonic acid | — | — | — | — | — | — | — | 0.6 | — | — | — | — | — | — | — |
| | Tetrabutylammonium | — | — | — | — | — | — | — | — | — | — | — | — | — | — | — |
| | hydroxide | | | | | | | | | | | | | | | |

| | | | | | | | | | | | | | | | |
|---|---|---|---|---|---|---|---|---|---|---|---|---|---|---|---|
| Thermal weight loss (%) | 5 | 5 | 3 | 3 | 3 | 4 | 3 | 3 | 3 | 5 | 4 | 3 | 3 | 3 | 5 |
| Adhesion | ∘ | ∘ | Δ | Δ | ∘ | Δ | ∘ | Δ | ∘ | ∘ | ∘ | ∘ | ∘ | ∘ | ∘ |
| Transparency | ∘ | ∘ | ∘ | ∘ | ∘ | ∘ | ∘ | ∘ | ∘ | ∘ | ∘ | ∘ | ∘ | ∘ | ∘ |
| Bending test | Δ | Δ | x | x | Δ | Δ | Δ | x | ∘ | ∘ | ∘ | ∘ | ∘ | ∘ | ∘ |

TABLE 3

| | | Example | | | | | | | | | | | Comparative Example | | | |
|---|---|---|---|---|---|---|---|---|---|---|---|---|---|---|---|---|
| | | 16 | 17 | 18 | 19 | 20 | 21 | 22 | 23 | 24 | 25 | 26 | 1 | 2 | 3 | 4 |
| Resin solution No. | | 8 | 9 | 10 | 10 | 10 | 11 | 12 | 13 | 14 | 15 | 16 | 1 | 2 | 4 | 1 |
| (parts) | | 100 | 100 | 100 | 100 | 100 | 100 | 100 | 100 | 100 | 100 | 100 | 100 | 100 | 100 | 100 |
| Additive | Triphenylphosphine | — | — | — | — | 3.0 | — | — | — | — | — | — | — | — | — | — |
| (parts) | Trioctylphosphine | — | — | — | — | — | — | — | — | — | — | — | — | — | — | — |
| | Phenylphosphinic acid | 0.6 | — | — | — | — | — | — | — | — | — | — | — | — | — | — |
| | Methyl phosphate | — | — | — | — | — | — | — | — | — | — | — | — | — | — | — |
| | (mixture of mono- | | | | | | | | | | | | | | | |
| | and diesters) | | | | | | | | | | | | | | | |
| | 2-Ethylhexyl | — | — | 0.6 | 3.0 | — | 0.6 | 0.6 | 0.6 | 0.6 | 0.6 | 0.7 | — | — | — | — |
| | phosphate | | | | | | | | | | | | | | | |
| | (mixture of mono- | | | | | | | | | | | | | | | |
| | and diesters) | | | | | | | | | | | | | | | |
| | Dibutyl phosphate | — | — | — | — | — | — | — | — | — | — | — | — | — | — | — |
| | Diphenyl phosphate | — | — | — | — | — | — | — | — | — | — | — | — | — | — | — |
| | Phenylphosphonic acid | — | 0.6 | — | — | — | — | — | — | — | — | — | — | — | — | — |
| | Tetrabutylammonium | — | — | — | — | — | — | — | — | — | — | — | — | — | — | 0.6 |
| | hydroxide | | | | | | | | | | | | | | | |

| | | | | | | | | | | | | | | | |
|---|---|---|---|---|---|---|---|---|---|---|---|---|---|---|---|
| Thermal weight loss (%) | 3 | 3 | 3 | 2 | 3 | 3 | 3 | 4 | 4 | 5 | 2 | 6 | 4 | 5 | 10 |
| Adhesion | Δ | Δ | ∘ | ∘ | ∘ | ∘ | ∘ | ∘ | ∘ | ∘ | ∘ | x | x | x | x |
| Transparency | ∘ | ∘ | ∘ | ∘ | ∘ | ∘ | ∘ | ∘ | ∘ | ∘ | ∘ | ∘ | ∘ | ∘ | Failed |
| Bending test | ∘ | ∘ | ∘ | ∘ | ∘ | ∘ | ∘ | ∘ | ∘ | ∘ | ∘ | x | ∘ | ∘ | Failed |

TABLE 4

| | | Example | | | | | | | | | | | | |
|---|---|---|---|---|---|---|---|---|---|---|---|---|---|---|
| | | 27 | 28 | 29 | 30 | 31 | 32 | 33 | 34 | 35 | 36 | 37 | 38 | 39 |
| Resin solution No. | | 17 | 17 | 17 | 17 | 17 | 17 | 17 | 17 | 18 | 18 | 19 | 19 | 19 |
| (parts) | | 100 | 100 | 100 | 100 | 100 | 100 | 100 | 100 | 100 | 100 | 100 | 100 | 100 |
| Additive (parts) | 2-Ethylhexyl phosphate | 1.4 | 1.4 | 1.4 | — | — | — | — | — | — | — | — | — | — |
| | (mixture of mono- and diesters) | | | | | | | | | | | | | |
| | Diphenyl phosphate | — | — | — | 1.4 | — | — | — | — | 1.4 | — | 1.4 | — | — |
| | 1,3,5-Triazine-2,4,6-trithiol | — | — | — | — | 1.4 | — | — | — | — | — | — | — | — |
| | 6-(Dibutylamino)-1,3,5-triazine- | — | — | — | — | — | 1.4 | — | — | — | — | — | — | — |
| | 2,4-dithiol | | | | | | | | | | | | | |
| | 6-(Diisopropylamino)-1,3,5- | — | — | — | — | — | — | 1.4 | 1.4 | — | 1.4 | — | 1.4 | — |
| | triazine-2,4-dithiol | | | | | | | | | | | | | |
| | Benzoic acid | — | — | — | — | — | — | — | — | — | — | — | — | 1.4 |
| | 4-Phenylbenzoic acid | — | — | — | — | — | — | — | — | — | — | — | — | — |
| | 4-Phenylphenol | — | — | — | — | — | — | — | — | — | — | — | — | — |
| | ADK STAB AO-20 (ADEKA) | — | 0.4 | — | 0.4 | 0.4 | 0.4 | 0.4 | — | 0.4 | 0.4 | 0.4 | 0.4 | — |
| | ADK STAB AO-80 (ADEKA) | — | — | 0.4 | — | — | — | — | — | — | — | — | — | 0.4 |

| | | | | | | | | | | | | | |
|---|---|---|---|---|---|---|---|---|---|---|---|---|---|
| Thermal weight loss (%) | 3 | 3 | 3 | 3 | 4 | 5 | 5 | 5 | 4 | 5 | 4 | 5 | 5 |
| Adhesion | ∘ | ∘ | ∘ | ∘ | ∘ | ∘ | ∘ | ∘ | ∘ | ∘ | ∘ | ∘ | ∘ |
| Transparency | ∘ | ∘ | ∘ | ∘ | ∘ | ∘ | ∘ | ∘ | ∘ | ∘ | ∘ | ∘ | ∘ |
| Bending test | ∘ | ∘ | ∘ | ∘ | ∘ | ∘ | ∘ | ∘ | ∘ | ∘ | ∘ | ∘ | ∘ |
| Resistance to thermal cracking | Δ | ∘ | ∘ | ∘ | ∘ | ∘ | ∘ | Δ | ∘ | ∘ | ∘ | ∘ | ∘ |

| | | | | | | | | | | | | Comparative | | |
|---|---|---|---|---|---|---|---|---|---|---|---|---|---|---|
| | | Example | | | | | | | | | | Example | | |
| | | 40 | 41 | 42 | 43 | 44 | 45 | 46 | 47 | 48 | 49 | 5 | 6 | 7 |
| Resin solution No. | | 19 | 19 | 20 | 20 | 21 | 21 | 22 | 22 | 23 | 23 | 17 | 18 | 19 |
| (parts) | | 100 | 100 | 100 | 100 | 100 | 100 | 100 | 100 | 100 | 100 | 100 | 100 | 100 |
| Additive (parts) | 2-Ethylhexyl phosphate | — | — | — | — | — | — | — | — | — | — | — | — | — |
| | (mixture of mono- and diesters) | | | | | | | | | | | | | |
| | Diphenyl phosphate | — | — | 1.6 | — | 1.6 | — | 1.6 | — | 1.6 | — | — | — | — |
| | 1,3,5-Triazine-2,4,6-trithiol | — | — | — | — | — | — | — | — | — | — | — | — | — |
| | 6-(Dibutylamino)-1,3,5-triazine- | — | — | — | — | — | — | — | — | — | — | — | — | — |
| | 2,4-dithiol | | | | | | | | | | | | | |
| | 6-(Diisopropylamino)-1,3,5- | — | — | — | — | — | — | — | — | — | — | — | — | — |
| | triazine-2,4-dithiol | | | | | | | | | | | | | |
| | Benzoic acid | — | — | — | 1.6 | — | 1.6 | — | 1.6 | — | 1.6 | — | — | — |
| | 4-Phenylbenzoic acid | 1.4 | — | — | — | — | — | — | — | — | — | — | — | — |
| | 4-Phenylphenol | — | 1.4 | — | — | — | — | — | — | — | — | — | — | — |
| | ADK STAB AO-20 (ADEKA) | — | — | — | — | — | — | — | — | — | — | — | — | — |
| | ADK STAB AO-80 (ADEKA) | 0.4 | 0.4 | 0.4 | 0.4 | 0.4 | 0.4 | 0.4 | 0.4 | 0.4 | 0.4 | — | — | — |

| | | | | | | | | | | | | | |
|---|---|---|---|---|---|---|---|---|---|---|---|---|---|
| Thermal weight loss (%) | 5 | 5 | 2 | 3 | 3 | 4 | 3 | 4 | 3 | 4 | 4 | 4 | 4 |
| Adhesion | ∘ | ∘ | ∘ | Δ | ∘ | ∘ | ∘ | ∘ | ∘ | ∘ | x | x | x |
| Transparency | ∘ | ∘ | ∘ | ∘ | ∘ | ∘ | ∘ | ∘ | ∘ | ∘ | ∘ | ∘ | ∘ |
| Bending test | ∘ | ∘ | Δ | Δ | ∘ | ∘ | ∘ | ∘ | ∘ | ∘ | ∘ | ∘ | ∘ |
| Resistance to thermal cracking | ∘ | ∘ | ∘ | ∘ | ∘ | ∘ | ∘ | ∘ | ∘ | ∘ | x | x | x |

Tables 1 to 4 demonstrate that the compositions of the examples containing polysilsesquioxanes and predetermined compounds can provide cured products having excellent resistance to thermal decomposition and excellent adhesion to metal base materials. The cured products also have excellent transparency. The compositions containing polysilsesquioxanes each containing an alkyl group having a carbon number of 3 to 10 also have excellent flexibility. Further, the presence of a hindered phenolic antioxidant improves the resistance to thermal cracking.

The polysilsesquioxane composition of Example 1, 9, 11, or 12 was applied to each of a silicon wafer and a silicon wafer with 300 nm of silicon dioxide, each serving as a base material, and dried at 100° C. for 30 minutes, followed by drying at 200° C. for one hour. Thus, a 20-μm-thick coating was formed on a surface of each base material. Thereafter, each coating was heat-treated at 400° C. for one hour in a nitrogen atmosphere, and then subjected to a tape peel test using Scotch tape. The results show that each coating did not peel off and exhibited good adhesion.

Also, coatings of the polysilsesquioxane compositions of Comparative Examples 1, 2, and 3 were formed and subjected to a tape peel test by the same technique as described above. The results show that each coating peeled from both the silicon wafer and the silicon wafer with 300 nm of silicon dioxide and exhibited poor adhesion.

1. A polysilsesquioxane composition comprising:
a polysilsesquioxane; and
at least one compound selected from the group consisting of phosphorus-containing compounds, triazinethiol compounds, hydroxy group-containing compounds having a boiling point of 230° C. or higher, and carboxy group-containing compounds having a boiling point of 230° C. or higher,
the phosphorus-containing compounds including at least one selected from the group consisting of phosphine compounds, phosphate compounds, phosphinate compounds, and phosphonate compounds, and
the polysilsesquioxane containing a backbone represented by the following formula (1):
[R¹SiO_{1.5}]ₙ (1)
wherein R¹ represents an alkyl group having a carbon number from 1 to 10, an aryl group, or a vinyl structure-containing group,
the alkyl group having a carbon number from 1 to 10 and the aryl group each optionally have a substituent,
n is an integer of 1 or more,
n R¹s are optionally the same as or different from each other, and
the polysilsesquioxane contains at least the backbone represented by the formula (1) in which R¹ is the alkyl group having the carbon number from 1 to 10 and the backbone represented by the formula (1) in which R¹ is the aryl group.

2-3. (canceled)

4. The polysilsesquioxane composition according to claim 1,
wherein the polysilsesquioxane contains at least the backbone represented by the formula (1) in which R¹ is the alkyl group having a carbon number from 3 to 10 and the backbone represented by the formula (1) in which R¹ is the aryl group.

5. The polysilsesquioxane composition according to claim 1,
wherein the polysilsesquioxane contains at least the backbone represented by the formula (1) in which R¹ is a methyl group, the backbone represented by the formula (1) in which R¹ is the alkyl group having a carbon number from 3 to 10, and the backbone represented by the formula (1) in which R¹ is the aryl group.

6. The polysilsesquioxane composition according to claim 1,
wherein the polysilsesquioxane contains at least the backbone represented by the formula (1) in which R¹ is the alkyl group having a carbon number from 3 to 10, the backbone represented by the formula (1) in which R¹ is the aryl group and the backbone represented by the formula (1) in which R¹ is the vinyl structure-containing group.

7. The polysilsesquioxane composition according to claim 4,
wherein an amount of carbon in the alkyl group having the carbon number from 3 to 10 is 3% by mass or more of a total amount of carbon in the polysilsesquioxane.

8. The polysilsesquioxane composition according to claim 1,
wherein the polysilsesquioxane contains a structural unit represented by the following formula (1′) in an amount of 40 mol % or more based on 100 mol % of all structural units of the polysilsesquioxane,
[R¹SiO_{1.5}] (1′)
wherein R¹ represents an alkyl group having a carbon number from 1 to 10, an aryl group, or a vinyl structure-containing group; and the alkyl group having a carbon number from 1 to 10 and the aryl group each optionally have a substituent.

9. The polysilsesquioxane composition according to claim 1,
wherein the polysilsesquioxane further contains a backbone represented by the following formula (2):
[R²R³SiO_{1.0}]ₘ (2)
wherein R² and R³ are the same as or different from each other and each represent an alkyl group having a carbon number from 1 to 10, an aryl group, a vinyl structure-containing group, or —OR⁴;
the alkyl group having a carbon number from 1 to 10 and the aryl group each optionally have a substituent;
R⁴ represents a hydrogen atom, an alkyl group, an aryl group, or an acetyl group; and
m R²s are optionally the same as or different from each other, and
m R³s are optionally the same as or different from each other.

10. The polysilsesquioxane composition according to claim 1, wherein the phosphine compounds have a boiling point of 100° C. or higher.

11. The polysilsesquioxane composition according to claim 1, further comprising a hindered phenolic antioxidant.

12. An optical material obtained from the poylsilsesquioxane composition according to claim 1.

13. A low dielectric material obtained from the poylsilsesquioxane composition according to claim 1.

14. A cured product obtained by curing the polysilsesquioxane composition according to claim 1.

15. A method for using a polysilsesquioxane composition according to claim 1 as an optical material.

16. A method for using a polysilsesquioxane composition according to claim 1 as a low dielectric material.
